(19) United States
(12) Patent Application Publication
(10) Pub. No.: US 2024/0132681 A1
(43) Pub. Date: Apr. 25, 2024

(54) POLYETHYLENE COPOLYMERS AND TERPOLYMERS FOR TIE LAYERS AND METHODS THEREOF

(71) Applicant: Braskem S.A., Camaçari (BR)

(72) Inventors: Murilo Lauer Sanson, São Paulo City (BR); Hadi Mohammadi, Philadelphia, PA (US); Nei Sebastião Domingues Junior, São Paulo City (BR)

(73) Assignee: Braskem S.A., Camaçari (BR)

(21) Appl. No.: 18/374,926

(22) Filed: Sep. 29, 2023

Related U.S. Application Data
(60) Provisional application No. 63/412,187, filed on Sep. 30, 2022.

(51) Int. Cl. C08J 5/18; C08F 218/10; C08L 23/08

(52) U.S. Cl. CPC C08J 5/18; C08F 218/10; C08L 23/0853; C08L 2201/10; C08L 2201/14; C08L 2203/30

(57) ABSTRACT

Provided is a tie layer film, comprising a polymer composition comprising a polymer produced from ethylene, one or more branched vinyl ester monomers, and optionally, vinyl acetate, with an ethylene content in an amount ranging from 40 to 99.9 wt %, and having a melt index (I2) from 0.1 to 100 g/10 min, measured according to ASTM D1238 (190° C. and load of 2.16 kg). Also provided is an article comprising two substrates and a film, and a method of manufacturing an article.

### BACKGROUND

Polymers that are used as tie layers in multilayered structures (e.g. flexible food packaging, containers, bottles, blow molded tanks, pipes, or other applications that demand properties such as gas barriers, while maintaining mechanical properties and cost requirements), have the main role of assuring good adhesion between outer and inner layers, which are commonly dissimilar—for example, polyethylene or polypropylene in an outer layer, and poly(ethylene-co-vinyl alcohol) or polyamide in an inner layer. Therefore, it might be a combination of materials that do not naturally leads to good compatibility and adhesion, thus, the use of a third polymer, that can combine characteristics of inner and outer layers is a strategy to overcome this scenario. Two main strategies are used for the selection of a tie layer material: 1. Using a co or terpolymer using comonomers with different chemical characteristic that will enable good interactions (e.g. Van der Waals forces, hydrogen bonding, co-crystallization, etc.) with both polymers in the layered structure; 2. The use of a co or terpolymer with a fraction that is chemically similar/compatible to one polymer (usually an apolar one), and another fraction containing a functional group that will lead to reactive adhesion with the other.

Poly (ethylene-co-vinyl acetate) (EVA) is a common base for tie layer grades, both when neat and grafted with functional groups (with the main examples of maleic anhydride and acrylic acid). The present invention claims the use of a terpolymer comprising of ethylene, vinyl acetate and vinyl neodecanoate (VeoVa™10) as a base for a tie layer polymer.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a tie layer film, comprising a polymer composition comprising a polymer produced from ethylene, one or more branched vinyl ester monomers, and optionally, vinyl acetate, with an ethylene content in an amount ranging from 40 to 99.9 wt %, and having a melt index (I₂) from 0.1 to 100 g/10 min, measured according to ASTM D1238 (190° C. and load of 2.16 kg).

In another aspect, embodiments disclosed herein relate to a method for producing a film comprising cast film extruding, blown film extruding, calendaring, extrusion blow molding, injection molding, injection stretch blow molding, pipe extruding, or thermoforming a tie layer film, comprising a polymer composition comprising a polymer produced from ethylene, one or more branched vinyl ester monomers, and optionally, vinyl acetate, with an ethylene content in an amount ranging from 40 to 99.9 wt %, and having a melt index (I₂) from 0.1 to 100 g/10 min, measured according to ASTM D1238 (190° C. and load of 2.16 kg).

In another aspect, embodiments disclosed herein relate to an article comprising two substrates and the film comprising a polymer composition comprising a polymer produced from ethylene, one or more branched vinyl ester monomers, and optionally, vinyl acetate, with an ethylene content in an amount ranging from 40 to 99.9 wt %, and having a melt index (I₂) from 0.1 to 100 g/10 min, measured according to ASTM D1238 (190° C. and load of 2.16 kg).

In another aspect, embodiments disclosed herein relate to method of manufacturing an article, comprising applying a film comprising a polymer composition comprising a polymer produced from ethylene, one or more branched vinyl ester monomers, and optionally, vinyl acetate, with an ethylene content in an amount ranging from 40 to 99.9 wt %, and having a melt index (I₂) from 0.1 to 100 g/10 min, measured according to ASTM D1238 (190° C. and load of 2.16 kg) to a substrate; and positioning a second substrate on the film.

Other aspects and advantages of the claimed subject matter will be apparent from the following description and the appended claims.

### DETAILED DESCRIPTION

Embodiments disclosed herein relate to films comprising a polymer composition comprising a polymer produced from ethylene, one or more branched vinyl ester monomers, and optionally, vinyl acetate, with an ethylene content in an amount ranging from 40 to 99.9 wt %. In one or more embodiments, polymer compositions may be prepared from a reaction of ethylene and one or more branched vinyl esters and/or vinyl acetate monomers that modify various properties of the formed copolymer, and films formed therefrom, including density; melt index (I₂); melting temperature; electrical resistivity; hardness; softening point; optical transmittance; haze; water vapor transmission; mechanical strength; UV cut-off wavelength; gloss; crystallinity; and glass transition temperature, among others.

Advantageously, the present disclosure displays that the inclusion of branched vinyl ester instead of or in conjunction with vinyl acetate may decrease water vapor transmission rate (WVTR) while enhancing low temperature flexibility.

### Polymer Compositions

### Co- and Ter-Polymers

Co- and ter-polymers of the present disclosure may be produced from ethylene, one or more branched vinyl ester monomers, and optionally, vinyl acetate, with an ethylene content in an amount ranging from 40 to 99.9 wt %.

### Branched Vinyl Ester Monomers

In one or more embodiments, branched vinyl esters may include branched vinyl esters generated from isomeric mixtures of branched alkyl acids. Branched vinyl esters in accordance with the present disclosure may have the general chemical formula (I):

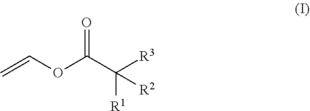

where R¹, R², and R³ have a combined carbon number in the range of C3 to C20. In some embodiments, R¹, R², and R³ may all be alkyl chains having varying degrees of branching in some embodiments, or a subset of R¹, R², and R³ may be independently selected from a group consisting of hydrogen, alkyl, or aryl in some embodiments.

In one or more embodiments, the vinyl carbonyl monomers may include branched vinyl esters having the general chemical formula (II):

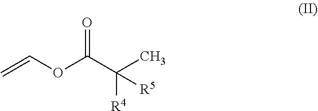

wherein R⁴ and R⁵ have a combined carbon number of 6 or 7 and the polymer composition has a number average molecular weight (Mₙ) ranging from 5 kDa to 10000 kDa obtained by GPC. In one or more embodiments, R⁴ and R⁵ may have a combined carbon number of less than 6 or greater than 7, and the polymer composition may have an Mₙ up to 10000 kDa. That is, when the Mₙ is less than 5 kDa, R⁴ and R⁵ may have a combined carbon number of less than 6 or greater than 7, but if the Mₙ is greater than 5 kDa, such as in a range from 5 to 10000 kDa, R⁴ and R⁵ may include a combined carbon number of 6 or 7. In particular embodiments, R⁴ and R⁵ have a combined carbon number of 7, and the Mₙ may range from 5 to 10000 kDa. Further in one or more particular embodiments, a vinyl carbonyl according to Formula (II) may be used in combination with vinyl acetate.

Examples of branched vinyl esters may include monomers having the chemical structures, including derivatives thereof:

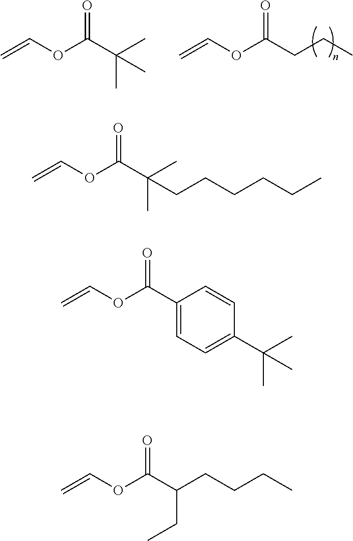

In one or more embodiments, the polymer compositions may include polymers generated from monomers derived from petroleum and/or renewable sources.

In one or more embodiments, branched vinyl esters may include monomers and comonomer mixtures containing vinyl esters of neononanoic acid, neodecanoic acid, and the like. In some embodiments, branched vinyl esters may include Versatic™ acid series tertiary carboxylic acids, including Versatic™ acid EH, Versatic™ acid 9 and Versatic™ acid 10 prepared by Koch synthesis, commercially available from Hexion™ chemicals. In one or more embodiments, the polymer compositions may include polymers generated from monomers derived from petroleum and/or renewable sources.

Co- or ter-polymers that include a branched vinyl ester monomer in accordance with the present disclosure may include a percent by weight of ethylene measured by proton nuclear magnetic resonance (¹H NMR) and Carbon 13 nuclear magnetic resonance (¹³C NMR) that ranges from a lower limit selected from one of 40 wt %, 45 wt %, 50 wt %, 55 wt %, 60 wt %, 65 wt % 70 wt %, and 75 wt %, to an upper limit selected from one of 75 wt % 80 wt %, 85 wt %, 90 wt %, 95 wt %, 99 wt %, or 99.9 wt % where any lower limit may be paired with any upper limit.

Co- or ter-polymers that include a branched vinyl ester monomer in accordance with the present disclosure may include a percent by weight of vinyl ester monomer, such as that of Formula (I) and (II) above, measured by ¹H NMR and ¹³C NMR that ranges from a lower limit selected from one of 0.01 wt %, 0.1 wt %, 1 wt %, 5 wt %, 10 wt %, 20 wt %, or 30 wt % to an upper limit selected from 30 wt %, 35 wt %, 40 wt %, 45 wt %, 50 wt %, 55 wt %, or 60 wt % where any lower limit may be paired with any upper limit.

In some embodiments, co- or ter-polymers that include a branched vinyl ester monomer in accordance with the present disclosure may optionally include a percent by weight of vinyl acetate measured by ¹H NMR and ¹³C NMR that ranges from a lower limit selected from one of 0 wt %, 0.01 wt %, 0.1 wt %, 1 wt %, 5 wt %, 10 wt %, 20 wt %, 25 wt % or 30 wt % to an upper limit selected from 30 wt %, 35 wt %, 40 wt %, 45 wt %, 50 wt %, 55 wt %, or 59.99 wt % where any lower limit may be paired with any upper limit. For the polymer samples containing the vinyl acetate and vinyl ester monomers, incorporation may be determined using quantitative ¹³C NMR, since the ¹H NMR contains significant overlap in both the carbonyl and alkyl regions for accurate integration. Evidence of incorporation of the branched vinyl ester and vinyl acetate is seen in both the carbonyl (170-180 ppm) and alkyl regions (0-50 ppm) of the ¹³C NMR spectra (TCE-D2, 393.1 K, 125 MHZ). ¹H NMR spectra (TCE-D2. 393.2 K, 500 MHz) exhibit peaks for vinyl acetate and branched vinyl ester (4.7-5.2 ppm) and ethylene (1.2-1.5 ppm) as well as additional peaks in the alkyl region (0.5-1.5 ppm) indicative of the long alkyl chains on the branched vinyl ester monomers. Relative intensity of the peaks found in ¹H NMR and ¹³C NMR spectra are used to calculate monomer incorporation of branched vinyl ester and vinyl acetate in the co-/terpolymers.

Co- or ter-polymers that include a branched vinyl ester monomer in accordance with the present disclosure may have a number average molecular weight (Mₙ) in kilodaltons (kDa) measured by gel permeation chromatography (GPC) that ranges from a lower limit selected from one of 1 kDa, 5 kDa, 10 kDa, 15 kDa, and 20 kDa to an upper limit selected from one of 40 kDa, 50 kDa, 100 kDa, 300 kDa, 500 kDa, 1000 kDa, 5000 kDa, and 10000 kDa, where any lower limit may be paired with any upper limit.

Co- or ter-polymers that include a branched vinyl ester monomer in accordance with the present disclosure may have a weight average molecular weight (M_{w}) in kilodaltons (kDa) measured by GPC that ranges from a lower limit selected from one of 1 kDa, 5 kDa, 10 kDa, 15 kDa and 20 kDa to an upper limit selected from one of 40 kDa, 50 kDa, 100 kDa, 200 kDa, 300 kDa, 500 kDa, 1000 kDa, 2000 kDa, 5000 kDa, 10000 kDa, and 20000 kDa, where any lower limit may be paired with any upper limit.

Co- or ter-polymers that include a branched vinyl ester monomer in accordance with the present disclosure may have a molecular weight distribution (MWD, defined as the ratio of M_{w} over Mₙ) measured by GPC that has a lower limit of any of 1, 1.5, 2, 5, or 10, and an upper limit of any of 20, 30, 40, 50, or 60, where any lower limit may be paired with any upper limit.

GPC analysis may be carried out in a gel permeation chromatography coupled with triple detection, with an infrared detector IR5 and a four bridge capillary viscometer, both from PolymerChar and an eight angle light scattering detector from Wyatt. A set of 4 column, mixed bed, 13 μm from Tosoh in a temperature of 140° C. may be used. The experiments may be carried out in the following conditions: concentration of 1 mg/mL. flow rate of 1 mL/min, dissolution temperature and time of 160° C. and 90 minutes, respectively and an injection volume of 200 μL. The solvent used was TCB (Trichloro benzene) stabilized with 100 ppm of BHT.

In one or more embodiments, co- or ter-polymers that includes a branched vinyl ester monomer in accordance with the present disclosure may be prepared in reactor by polymerizing ethylene and one or more branched vinyl ester monomers, and optionally a vinyl acetate comonomer, as described for example in U.S. Patent Publication No. 2021/0102014, which is herein incorporated by reference in its entirety. Methods of reacting the comonomers in the presence of a radical initiator may include any suitable method in the art including solution phase polymerization, pressurized radical polymerization, bulk polymerization, emulsion polymerization, and suspension polymerization. In some embodiments, the reactor may be a batch autoclave reactor at temperatures below 150° C. and pressures below 500 bar, known as low pressure polymerization system. In some embodiments, the comonomers and one or more free-radical polymerization initiators are polymerized in a continuous or batch process at temperatures above 150° C. and at pressures above 1000 bar, known as high pressure polymerization systems. Copolymers and terpolymers produced under high pressure conditions may have number average molecular weights of 5 to 40 kDa, weight average molecular weights of 5 to 400 kDa and MWDs of 2 to 10.

In one or more embodiments, the reaction is carried out in a low pressure polymerization process wherein the ethylene and one or more branched vinyl ester monomers, and optionally a vinyl acetate comonomer are polymerized in a liquid phase of an inert solvent and/or one or more liquid monomer(s). In one embodiment, polymerization comprises initiators for free-radical polymerization in an amount from about 0.001 to about 0.01 millimoles calculated as the total amount of one or more initiator for free-radical polymerization per liter of the volume of the polymerization zone. The amount of ethylene in the polymerization zone will depend mainly on the total pressure of the reactor in a range from about 20 bar to about 100 bar and temperature in a range from about 20° C. to about 125° C. The liquid phase of the polymerization process in accordance with the present disclosure may include ethylene, one or more branched vinyl ester monomers, and optionally a vinyl acetate comonomer, initiator for free-radical polymerization, and optionally one or more inert solvent such as tetrahydrofuran (THF), chloroform, dichloromethane (DCM), dimethyl sulfoxide (DMSO), dimethyl carbonate (DMC), hexane, cyclohexane, ethyl acetate (EtOAc) acetonitrile, toluene, xylene, ether, dioxane, dimethyl-formamide (DMF), benzene or acetone. Copolymers and terpolymers produced under low-pressure conditions may exhibit number average molecular weights of 2 to 20 kDa, weight average molecular weights of 4 to 100 kDa and MWDs of 2 to 5.

### Additives

In one or more embodiments, polymer compositions according to the present disclosure may include one or more additives including, but not limited to grafting agents, adhesion promoters, primary antioxidants, secondary antioxidants, acid scavengers, pigments, anti-fogging agents, antistatic agents, processing aids, antiblock agents, clarifiers, nucleating agents, light stabilizers, UV absorbers, thermal stabilizers, plasticizers, rubbers, elastomers, fillers, and combinations thereof.

### Grafting Agents

Polymer compositions in accordance with the present disclosure may include at least one grafting agent which may comprise one or more molecule (such as organic peroxides or azo initiators) capable of generating free radicals during polymer processing that will enable a grafting reaction with molecules containing desired functional groups. In one or more embodiments, peroxides may include bifunctional peroxides such as benzoyl peroxide; dicumyl peroxide; di-tert-butyl peroxide; OO-Tert-amyl-O-2-ethylhexyl monoperoxycarbonate; tert-butyl cumyl peroxide; tert-butyl 3,5,5-trimethylhexanoate peroxide; tert-butyl peroxybenzoate; 2-ethylhexyl carbonate tert-butyl peroxide; 2.5-dimethyl-2,5-di (tert-butylperoxide) hexane; 1,1-di (tert-butylperoxide)-3,3,5-trimethylcyclohexane; 2,5-dimethyl-2.5-di(tert-butylperoxide) hexyne-3; 3,3,5,7,7-pentamethyl-1,2,4-trioxepane; butyl 4,4-di (tert-butylperoxide) valerate; di (2,4-dichlorobenzoyl) peroxide; di(4-methylbenzoyl) peroxide; peroxide di(tert-butylperoxyisopropyl) benzene; and the like.

Peroxides may also include benzoyl peroxide, 2,5-di(cumylperoxy)-2,5-dimethyl hexane, 2,5-di(cumylperoxy)-2,5-dimethyl hexyne-3,4-methyl-4-(t-butylperoxy)-2-pentanol, butyl-peroxy-2-ethyl-hexanoate, tert-butyl peroxypivalate, tertiary butyl peroxyneodecanoate, t-butyl-peroxy-benzoate, t-butyl-peroxy-2-ethyl-hexanoate, 4-methyl-4-(t-amylperoxy)-2-pentanol,4-methyl-4-(cumylperoxy)-2-pentanol, 4-methyl-4-(t-butylperoxy)-2-pentanone, 4-methyl-4-(t-amylperoxy)-2-pentanone, 4-methyl-4-(cumylperoxy)-2-pentanone, 2,5-dimethyl-2,5-di(t-butylperoxy)hexane, 2,5-dimethyl-2.5-di(t-amylperoxy)hexane, 2,5-dimethyl-2,5-di(t-butylperoxy)hexyne-3, 2,5-dimethyl-2,5-di(t-amylperoxy)hexyne-3, 2,5-dimethyl-2-t-butylperoxy-5-hydroperoxyhexane, 2,5-dimethyl-2-cumylperoxy-5-hydroperoxy hexane, 2,5-dimethyl-2-t-amylperoxy-5-hydroperoxyhexane, m/p-alpha, alpha-di[(t-butylperoxy)isopropyl]benzene, 1,3,5-tris(t-butylperoxyisopropyl)benzene, 1,3,5-tris(t-amylperoxyisopropyl)benzene, 1,3,5-tris( cumy lperoxyisopropyl)benzene, di[1,3-dimethyl-3-(t-butylperoxy)butyl]carbonate, di[1,3-dimethyl-3-(t-amylperoxy)butyl]carbonate, di[1,3-dimethyl-3-(cumylperoxy)butyl ]carbonate, di-t-amyl peroxide, t-amyl cumyl peroxide, t-butyl-isopropenylcumyl peroxide, 2,4,6-tri(10eptane10nyl10)-s-triazine, 1,3,5-tri[l-(t-butylperoxy)-1-methylethyl]benzene, 1,3,5-tri-[(t-butylperoxy)-isopropyl]benzene, 1,3-dimethyl-3-(t-butylperoxy)butanol, 1,3-dimethyl-3-(t-amylperoxy)butanol, di(2-phenoxyethyl)peroxydicarbonate, di(4-t- butylcyclohexyl)peroxydicarbonate, dimyristyl peroxydicarbonate, dibenzyl peroxydicarbonate, di(isobomyl)peroxydicarbonate, 3-cumylperoxy-1,3-dimethylbutyl methacrylate, 3-t-butylperoxy-1.3-dimethylbutyl methacrylate, 3-t-amylperoxy-1,3-dimethylbutyl methacrylate, tri(1,3-dimethyl-3-t-butylperoxy butyloxy)vinyl silane, 1,3-dimethyl-3-(t-butylperoxy)butyl N-[1-{3-(1-methylethenyl)-phenyl}1-methylethyl]carbamate, 1.3-dimethyl-3-(t-amylperoxy)butyl N-[1-{3(1-methylethenyl)-phenyl }-1-methylethyl]carbamate, 1,3-dimethyl-3-(cumylperoxy))butyl N-[1-{3-(1-methylethenyl)-phenyl}-1-methylethyl]carbamate, 1, 1-di(t-butylperoxy)-3,3,5-trimethylcyclohexane, 1, 1-di(t-butylperoxy)cyclohexane, n-butyl 4,4-di(t-amylperoxy)valerate, ethyl 3,3-di(t-butylperoxy)butyrate, 2.2-di(t-amylperoxy)propane, 3,6,6,9,9-pentamethyl-3-ethoxycabonylmethyl-1,2,4,5-tetraoxacyclononane, n-buty 1-4,4-bis(t-butylperoxy)valerate, ethyl-3,3-di(t-amylperoxy)butyrate, benzoyl peroxide, OO-t-butyl-O-hydrogen-monoperoxy-succinate, OO-t-amyl-O-hydrogen-monoperoxy-succinate, 3,6,9, triethyl-3,6,9-trimethyl-1,4,7-triperoxynonane (or methyl ethyl ketone peroxide cyclic trimer), methyl ethyl ketone peroxide cyclic dimer, 3,3,6,6,9,9-hexamethyl-1,2,4,5-tetraoxacyclononane, 2,5-dimethyl-2,5-di(benzoylperoxy)hexane, t-butyl perbenzoate, t-butylperoxy acetate,t-butylperoxy-2-ethyl hexanoate, t-amyl perbenzoate, t-amyl peroxy acetate, t-butyl peroxy isobutyrate, 3-hydroxy-1,1-dimethyl t-butyl peroxy-2-ethyl hexanoate, OO-t-amyl-O-hydrogen-monoperoxy succinate, OO-t-butyl-O-hydrogen-monoperoxy succinate, di-t-butyl diperoxyphthalate, t-butylperoxy (3,3,5-trimethylhexanoate), 1,4-bis(t-butylperoxycarbo)cyclohexane, t-butylperoxy-3,5,5-trimethylhexanoate, t-butyl-peroxy-(cis-3-carboxy)propionate, allyl 3-methyl-3-t-butylperoxy butyrate, OO-t-butyl-O-isopropylmonoperoxy carbonate, OO-t-butyl-O-(2-ethyl hexyl)monoperoxy carbonate, 1,1,1-tris[2-(t-butylperoxy-carbonyloxy)ethoxymethyl]propane, 1,1,1-tris[2-(t-amylperoxy-carbonyloxy)ethoxymethyl]propane, 1,1,1-tris[2-(cumylperoxy-cabonyloxy)ethoxymethyl]propane, OO-t-amyl-O-isopropylmonoperoxy carbonate, di( 4-methylbenzoyl)peroxide, di(3-methylbenzoyl)peroxide, di(2-methylbenzoyl)peroxide, didecanoyl peroxide, dilauroyl peroxide, 2,4-dibromo-benzoyl peroxide, succinic acid peroxide, dibenzoyl peroxide, di(2,4-dichloro-benzoyl)peroxide, and combinations thereof.

The amount of the grafting agent—when considering only the active component: the free-radical generator itself—may be in an amount ranging from a lower limit of 0.001, 0.01, 0.1, or 0.5 to an upper limit of 1, 2, or 3 parts per hundred rubber/resin (phr) relative to 100 phr of the polymer, where any lower limit may be used in combination with any suitable upper limit. In one or more embodiments the grafting agent may be in an amount ranging from 0.001 to 2 phr, or even in an amount from 0.01 to 1 phr.

### Adhesion Promoters

Functional groups can be grafted onto polymers for tie layer materials in order to assure reactive adhesion with specific polymers in a multilayered structure. For example, unsaturated molecules such as maleic anhydride, acrylic acid, methacrylic acid, glycidyl methacrylate, maleic acid, fumaric acid, tetrahydrophthalic anhydride, citraconic anhydride, itaconic anhydride, (2-Dodecen-1-yl)succinic anhydride, etc., or similar molecules, containing carboxylic acids, anhydrides, epoxides, etc, might be grafted through the use of free radicals (e.g. the use of organic peroxides or azo initiators) onto the polymers herein described in order to improve adhesion.

The amount of the adhesion promoter may be ranging from a lower limit of 0.01. 0.05, 0.1. 0.5, 1.0, 2.0, or 4.0 to an upper limit of 6.0, 8.0, 10.0, 12.0, or 15.0 parts per hundred rubber/resin (phr) relative to 100 phr of the polymer, where any lower limit may be used in combination with any suitable upper limit. In one or more embodiments the UV absorbent may be in an amount ranging from 0.1 to 15 phr.

### Antioxidants

In one or more embodiments, polymer compositions according to the present disclosure may include one or more antioxidants. Polymer compositions according to embodiments may include at least a primary and a secondary antioxidant. Antioxidants according to the present disclosure may include monophenol-type, bisphenol-type, polymeric phenol-type, Sulfur-containing and phosphite-type antioxidants.

Monophenol-based antioxidants include, among others, 2,6-di-tert-butyl-p-cresol, butylated hydroxyani sole, 2,6-di-tert-butyl-4-ethylphenol, etc. The bisphenol type antioxidants include 2,″-methylenebis(4-methyl-6-tert-butylphenol), 2,″-methylenebis(4-ethyl-6-tert butylphenol), 4,″-thiobis(3-methyl-6-tert-butylphenol), 4,″-butylidenebis(3-methyl-6-tert-butylphenol), 3,9-bis(1, 1-dimethyl-2-R-(3-tert-butyl-4-hydroxy-5-methylphenyl) propionyloxyethyl}2,4,9,10-tetroxaspiro-5,5-undecane, etc. The polymeric phenol-type antioxidants include 1,1,3-tris (2-methyl-4-hydroxy-5-tert-butylphenyl)butane, 1,3,5-trim ethyl-2,4,6-tris(3,5-di-tert-butyl-4-hydroxybenzyl)benzene, tetrakis-methylene-3-(″,″-di-tert-butyl-″-hydroxyphenyl) propionate methane, bis{(3,″-bis-″-hydroxy-″-tert-butyl phenyl)butyric acid glucose ester, 1,3,5-tris(″,″-di-tert-bu tyl-“-hydroxybenzyl)-s-triazine-2,4,6-(1H.3H,5H)trione, and triphenol (vitamin E).

Sulfur-containing antioxidants include dilauroylthio dipropionate, dimyristylthiodipropionate, and distearyl thiopro pionate.

Phosphite-type antioxidants include triphenyl phos phite, diphenylisodecyl phosphite, phenyldiisodecyl phos phite, 4,″-butylidene-bis(3-methyl-6-tert-butylphenyl-di tridecyl)phosphite, cyclic neopentane-tetrayl bis(octadecyl) phosphite, tris(mono and/or di)phenyl phosphite, diisodecyl pentaerythritol13eptane13nyle, 9,10-dihydro-9-Oxa-10-phosphaphenanthrene-10-oxide, 10-(3,5-di-tert-butyl-4-hydroxybenzyl)-9,10-dihydro-9-Oxa-10-phosphaphenanthrene-10 oxide, 10-decyloxy-9,10-dihydro-9-Oxa-10 phosphaphenanthrene, cyclic neopentane-tetrayl bis(2,4-di tert-butylphenyl)phosphite, cyclic neopentane-tetrayl bis(2. 6-di-tert-methylphenyl)phosphite, and 2.2-methylenebis(4,6-tert-butylphenyl)octyl phosphite.

In one or more embodiments, antioxidants of the phenol-type and phosphite-type may be used alone, or preferably in combination to increase thermal stability.

The amount of the antioxidant to be added may be ranging from a lower limit of 0.001, 0.01, 0.1, 0.2, 0.3, 0.4, 0.5, 1, or 2 to 0.5, 0.6, 0.7, 0.8, 0.9, 1, 2, 3, 4, or 5 parts per hundred rubber/resin (phr) relative to 100 phr of the polymer, where any lower limit may be combined with any suitable upper limit. In one or more embodiments the antioxidant may be in an amount ranging from 0.002 to 1 phr.

### Acid Scavenger

Acid scavenger agents such as zinc stearate, zinc oxide, calcium stearate, dihydrotalcite, and other acid scavengers known in the art, might be added to the mentioned composition in order to neutralize especially potential catalyst residues.

The amount of acid scavenger to be added may be ranging from a lower limit of 0.001, 0.01, 0.1, 0.2, 0.3, 0.4, 0.5, 1, or 2 to 0.5, 0.6, 0.7, 0.8, 0.9, 1, 2, 3, 4, or 5 parts per hundred rubber/resin (phr) relative to 100 phr of the polymer, where any lower limit may be combined with any suitable upper limit. In one or more embodiments the scavenger may be in an amount ranging from 0.002 to 1 phr.

### Processing Aids

Processing aids such as fluoropolymers and fluoroelastomers, such as Viton™ series, thermoplastic elastomers based on block copolymers of diisocyanates and polyols (i.e. TPUs), polydimethysiloxanes and other siloxanes, including ultra-high molecular weight (UHMW) polydimethysiloxane, might be added to the described formulation in order to improve processability, avoiding melt fracture, thus allowing higher line speeds.

The amount of processing aids to be added may be ranging from a lower limit of 0.001, 0.005, 0.01, 0.1, 0.2, 0.3, 0.4, or 0.5, to 0.6, 0.7, 0.8, 0.9, 1, 2, 3, 4, or 5 parts per hundred rubber/resin (phr) relative to 100 phr of the polymer, where any lower limit may be combined with any suitable upper limit. In one or more embodiments, the processing aid may be added in an amount ranging from 0.002 to 1 phr.

### Antiblock Agents

Inorganic antiblock agents such as silica (natural or synthetic), talc, calcium carbonate, ceramic spheres (e.g. alumina, alumina silicate, etc.), clays, mica; organic antiblock agents such as bis-amides, primary and secondary amides (e.g. erucamides), organic and metallic stearates, silicone, PTFE, waxes (e.g. paraffinic wax) and other antiblock agents known in the art. It might be added in order to avoid blocking (i.e. the adhesion of two adjacent films), mainly by creating microscopic protrudes in the film surface, thus, decreasing interactions between the surface of the films (e.g. Van der Waal's forces).

The amount of antiblock agent to be added may be ranging from a lower limit of 0.001, 0.005, 0.01, 0.1, 0.2, 0.3, 0.4, or 0.5, to 0.6, 0.7, 0.8, 0.9, 1, 2, 3, 4, or 5 parts per hundred rubber/resin (phr) relative to 100 phr of the polymer, where any lower limit may be combined with any suitable upper limit. In one or more embodiments, the processing aid may be added in an amount ranging from 0.002 to 1 phr.

### Antistatic Agents

Organic antistatic agents such as phosphates (normally K or Na salts of the corresponding free acid), quaternary amines, non-ionic hygroscopic materials (i.e. surfactants of ethylene or propylene oxide), sulfate or sulfonated compounds, as well as conductive fillers and additives, such as carbon blacks, conductive fibers (e.g. carbon, steel, cellulose), graphite, metal powder of flakes, carbon nanotubes, inherently conductive polymers (ICP), and other antistatic agents known in the art, may be added to the present formulation in order to manage static charges during polymer processing and application, controlling the accumulation of electric charges in the surface of the polymer via some specific mechanism, for example, using charge structures, lone electron pairs or molecules with hygroscopic groups (can interact and bind with moisture present in the atmosphere). Dissipating these charges can avoid problems such as attracting dust and other pollutants, electrostatic build-up and discharges (which can avoid sparks, electric shock, etc.), painting and printing defects, fire or explosions under inflammable or explosive environments, etc.

The amount of antistatic agent to be added may be ranging from a lower limit of 0.001, 0.005, 0.01, 0.1, 0.2, 0.3, 0.4, or 0.5, to 0.6, 0.7, 0.8, 0.9, 1, 2, 3, 4, or 5 parts per hundred rubber/resin (phr) relative to 100 phr of the polymer, where any lower limit may be combined with any suitable upper limit. In one or more embodiments, the antistatic agent may be added in an amount ranging from 0.002 to 1 phr.

### Anti-Fogging Agents

Non-ionic anti-fogging agents such as ethoxylated alkylamines, sorbitan esters, polyglycerol stearates and glycerol sorbitan esters, and more specifically, glycerol ester (GE), octadecanoic acid (OA), polyglycerol ester (PE), polyglycerol stearate; 1,2,3-propanetriol (PS), polyglycerol monostearate (PM), sorbitan monostearate (SM), glyceril monooleate (GM), and other anti-fogging agents known in the art might be added in order to increase the wettability of the polymers, thus avoiding condensation and disruption of passage of light.

The amount of anti-fogging agent to be added may be ranging from a lower limit of 0.001, 0.005, 0.01, 0.1, 0.2, 0.3, 0.4, or 0.5, to 0.6, 0.7, 0.8, 0.9, 1, 2, 3, 4, or 5 parts per hundred rubber/resin (phr) relative to 100 phr of the polymer, where any lower limit may be combined with any suitable upper limit. In one or more embodiments, the processing aid may be added in an amount ranging from 0.002 to 1 phr.

### Light Stabilizer

The use of light stabilizers (LS) (especially hindered amine-type (HALS)) leads to a noticeable synergistic effect when combined with a UV-absorbent. Other LS typical compounds may function well playing the same role as the HALS, but many of them create color in the polymeric compound, and are therefore unfavorable for use in the solar cell encapsulant material. The hindered amine-type light stabilizers generally are secondary, tertiary, acetylated, N-hydrocarbyloxy substituted, hydroxy substituted, or other substituted cyclic amines with a considerable amount of steric hindrance. Specifically, it includes molecules such as dimethyl succinate-1-(2-hydroxyethyl)-4-hydroxy-2.2.6,6-tetramethyl piperidine polycondensate, poly(6-(1,1,3,3-tetramethylbutyl)amino-1,3,5-triazine-2,4-diy 1}{(2.2.6,6-tetramethyl-4-piperidyl)iminohexamethylene{{2.2.6,6-tetramethyl-4-piperidylimino, N,″-bis(3-aminopropyl) ethylenediamine-2,4-bis(N-butyl-N-(1.2.2.6,6-pentamethyl-4-piperidyl)amino-6-chloro-1,3,5-triazine condensate, bis (2.2.6,6-tetramethyl-4-piperidyl)sebacate, bis(1.2.2.6,6- pentamethyl-4-piperidyl)2-(3,5-di-tert-4-hydroxybenzyl)-2-n-butylmalonate, propandioic acid, C4-(methoxyphenyl)-methylene-, bis (1,2,2,6,6-pentamethyl-4-piperidinyl) ester, polymethylpropyl-3-oxy-4-(2.2,6,6-tetramethyl)piperidinylsiloxane, 3-Dodecyl-1-(2,2,6,6-tetramethyl-4-piperidinyl)-2,5- pyrrolidinedione, 1,3,5-Triazine-2,4,6-triamine,N,″-1,2-ethanediylbis 4,6-bis butyl(1,2,2,6,6-pentamethyl-4-16eptane16nyly) amino-1,3,5-triazine-2-yl)imino-3, 1 propanediyl)-bis″,″-dibutyl-″,″-bis(1,2,2,6,6-pentamethyl-4-piperidinyl)-(Chimassorb 119, CAS Reg. No. 106990-43-6); N,″-bis(2.2.6,6-Tetramethyl-4-piperidinyl)-1,6-hexane diamine, polymer with 2,4,6-trichloro-1,3,5-triazine and 2,4,4-trimethyl-1,2-pentamine (Chimassorb 944, ACS Reg. No. 70624-18-9); and N,″-bis (2,2,6,6-Tetramethyl-4-piperidinyl)-1,6-hexane diamine polymer with 2,4,6-trichloro-1,3,5-triazine and tetrahydro 1,4-oxazine.

The amount of the light stabilizer may be ranging from a lower limit of 0.001, 0.01, or 0.1 to and upper limit ranging from 0.2, 1, 3, or 5 phr relative to 100 phr of the polymer, where any lower limit may be used in combination with any suitable upper limit. In one or more embodiments, the light stabilizer may be in an amount ranging from 0.002 to 1 phr.

### UV Absorbers

Any known UV absorber may find utility within the present disclosure. General classes of UV absorbers that are preferred are benzophenone, benzotriazoles, triazine, salicylate, hydroxybenzophenones, hydroxyphenyl triazines, esters of substituted and unsubstituted benzoic acids, and the like and mixtures thereof.

Specific benzophenone UV absorbents include, for example, 2-hydroxy-4-methoxybenzophe none, 2-hydroxy-4-methoxy-2-carboxybenzophenone, 2-hydroxy-4-Octoxybenzophenone, 2-hydroxy-4-n-dodecy loxybenzophenone, 2-hydroxy-4-n-octadecyloxybenzophe none, 2-hydroxy-4-benzyloxybenzophenone, 2-hydroxy-4-methoxy-5-sulfobenzophenone, 2-hydroxy-5-chlorobenzophenone, 2,4-dihydroxybenzophenone, 2,″-dihydroxy-4-methoxybenzophenone, 2,″-dihydroxy-4,″-dimethoxybenzophenone, and 2,″,4,″-tetrahydroxybenzophenone.

The benzotriazole UV absorbents include hydroxy phenyl-substituted benzotriazole compounds, for example, 2-(2-hydroxy-5-methylphenyl)benzotriazole, 2-(2-hydroxy 5-t-butylphenyl)benzotriazole, 2-(2-hydroxy-3,5-dimethyl phenyl)benzotriazole, 2-(2-methyl-4-hydroxyphenyl)benzo triazole, 2-(2-hydroxy-3-methyl-5-t-butylphenyl) benzotriazole, 2-(2-hydroxy-3,5-di-t-amylphenyl) benzotriazole, and 2-(2-hydroxy-3,5-di-t-butylphenyl) benzotriazole.

The triazine UV absorbents include 2-4,6-bis(2,4-dimethylphenyl)-1,3,5-triazin-2-yl)-5-(octyloxy)phenol, 2-(4,6-diphenyl-1,3,5-triazin-2-yl)-5-(hexyloxy)phenol, etc. The salicylate-type UV absorbents include phenyl salicylate, and p-octylphenyl salicylate.

The amount of the UV absorbent may be ranging from a lower limit of 0.001, 0.01, 0.1, 0.2, 0.3, 0.4, or 0.5 to an upper limit of 0.5, 1.0, 2.0, 3.0, 4.0, or 5.0 parts per hundred rubber/resin (phr) relative to 100 phr of the polymer, where any lower limit may be used in combination with any suitable upper limit. In one or more embodiments the UV absorbent may be in an amount ranging from 0.002 to 1 phr.

### Thermal Stabilizer

Thermal stabilizers can be used in solar cell encapsulants, as an optional additive, in order to protect the polymer especially during processing, especially during the curing stage. Any regular thermal stabilizer may be used, which include but are not limited to: phenolic antioxidants, alkylated monophenols, alkylthiomethylphenols, hydroquinones, alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), peroxide deactivators, hydroxylamines, nitrones, thiosynergists, benzofuranones, indolinones, and mixtures thereof. Its use is optional and in some instances is not preferred (especially if it severely suppresses crosslinking).

The thermal stabilizer may be ranging from a lower limit of 0.001, 0.01, 0.1, or 0.2 to an upper limit ranging from 1, 2, 3, 4, or 5 phr relative to 100 phr of the polymer, where any lower limit may be used in combination with any suitable upper limit. In one or more embodiments, the thermal stabilizer may be in an amount ranging from 0.002 to 1 phr.

### Plasticizers

Polymer compositions in accordance with the present disclosure may contain one or more plasticizers to adjust the physical properties and processability of the composition. In some embodiments, plasticizers in accordance with the present disclosure may include one or more of bis(2-ethylhexyl) phthalate (DEHP), di-isononyl phthalate (DINP), bis (n-butyl) phthalate (DNBP), butyl benzyl phthalate (BZP), di-isodecyl phthalate (DIDP), di-n-octyl phthalate (DOP or DNOP), di-o-octyl phthalate (DIOP), diethyl phthalate (DEP), di-isobutyl phthalate (DIBP), di-n-hexyl phthalate, tri-methyl trimellitate (TMTM), tri-(2-ethylhexyl) trimellitate (TEHTM-MG), tri-(n-octyl, n-decyl) trimellitate, tri-(heptyl, nonyl) trimellitate, n-octyl trimellitate, bis (2-ethylhexyl) adipate (DEHA), dimethyl adipate (DMD), mono-methyl adipate (MMAD), dioctyl adipate (DOA)), dibutyl sebacate (DBS), polyesters of adipic acid such as VIERNOL, dibutyl maleate (DBM), di-isobutyl maleate (DIBM), benzoates, epoxidized soybean oils and derivatives, n-ethyl toluene sulfonamide, n-(2-hydroxypropyl) benzene sulfonamide, n-(n-butyl) benzene sulfonamide, tricresyl phosphate (TCP), tributyl phosphate (TBP), glycols/polyesters, triethylene glycol dihexanoate, 3gh), tetracthylene glycol di-heptanoate, polybutene, acetylated monoglycerides; alkyl citrates, triethyl citrate (TEC), acetyl triethyl citrate, tributyl citrate, acetyl tributyl citrate, trioctyl citrate, acetyl trioctyl citrate, trihexyl citrate, acetyl trihexyl citrate, butyryl trihexyl citrate, trihexyl o-butyryl citrate, trimethyl citrate, alkyl sulfonic acid phenyl ester, 2-cyclohexane dicarboxylic acid di-isononyl ester, nitroglycerin, butanetriol trinitrate, dinitrotoluene, trimethylolethane trinitrate , diethylene glycol dinitrate, tricthylene glycol dinitrate, bis (2,2-dinitropropyl) formal, bis (2,2-dinitropropyl) acetal, 2,2,2-trinitrocthyl 2-nitroxyethyl ether, mineral oils, vegetable or biobased oil, among other plasticizers and polymeric plasticizers. In particular embodiments, one of the one or more plasticizers may be mineral oil.

Polymer compositions in accordance with the present disclosure may optionally include plasticizers in an amount ranging from 0 to 20 phr. The plasticizer may be present in an amount ranging from a lower limit of one of 0 phr, 1.0 phr, 2.0 phr, and 5.0 phr, 8.0 phr and 10.0 phr, to an upper limit of one of 12 phr, 15 phr, 18 phr, 19 phr, and 20 phr where any lower limit may be combined with any suitable upper limit.

### Nucleating and Clarifying Agents

Polymer compositions in accordance with the present disclosure may contain one or more nucleating and/or clarifying agents, such as hexahydrophthalic acid metal salts, benzoic acid salts, stearates, organic phosphates, bisamides, sorbitols, metal carboxylates, metal aromatic carboxylates, polymeric agents, talc, clay, inorganic oxide particles and nanoparticles, and mixtures of the aforementioned chemicals. Sorbitols examples include, but are not restricted to, 1,3-p-methylbenzylidene-2,4-benzylidene sorbitol, 1,3-p-methylbenzylidene-2,4-p-ethylbenzylidene sorbitol, 1,3-p-ethylbenzylidene-2,4-benzylidene sorbitol, 1,3,2,4-dibenzylidene sorbitol, 1,3-benzylidene-2,4-p-methylbenzylidene sorbitol, 1,3-benzylidene-2,4-p-ethylbenzylidene sorbitol. Acid metal salts include, but are not restricted to, disodium salt of bicyclo[2.2.1]heptane-2,3-dicarboxylic acid, mixture of zinc stearate and a calcium salt of 1,2-cyclohexanedicarboxylic acid, disodium salt of bicyclo[2.2.1]heptane-2,3-dicarboxylic acid. Other compounds include, but are not restricted to, disodium bicyclo [2.2.1]20eptanee dicarboxylate; a bisamide; lithium carbonate; benzoic acid; nano-zinc oxide; talc; clay; powdered polymeric agent; polyphenylene oxide; polyvinylenedifluoride; polycarbonate; polycarbonate-siloxane copolymer; crosslinked polycarbonate; polyetherimide; polyamide; ethylene propylene diene monomer; polyoxymethylene; and other suitable nucleating agents and clarifiers known in the art.

The amount of nucleating and/or clarifying agent to be added may be ranging from a lower limit of 0.001, 0.005, 0.01, 0.1, 0.2, 0.3, 0.4, or 0.5, to 0.6, 0.7, 0.8, 0.9, 1, 2, 3, 4, or 5 parts per hundred rubber/resin (phr) relative to 100 phr of the polymer, where any lower limit may be combined with any suitable upper limit. In one or more embodiments, the nucleating and/or clarifying agent may be added in an amount ranging from 0.002 to 1 phr.

### Tie Layer

As mentioned above, the films of the present disclosure may be used as a tie layer, bringing together two dissimilar materials.

Tie layer films according to one or more embodiments may comprise a polymer (the co- or ter-polymer) having a total commoner content (branched vinyl ester and optional vinyl acetate) that ranges from a lower limit selected from one of 0.1 wt %, 1 wt %, 5 wt %, 10 wt %, 20 wt %, 25 wt %, or 30 wt % to an upper limit selected from 30 wt %, 35 wt %, 40 wt %, 45 wt %, 50 wt %, 55 wt %, or 60 wt % where any lower limit may be combined with any suitable upper limit.

Tie layer films according to one or more embodiments may comprise a polymer (the co- or ter-polymer) having a density that ranges from a lower limit selected from one of 0.8 g/cm3. 0.9 g/cm³, 0.905 g/cm³, 0.91 g/cm³, 0.915 g/cm³, 0.92 g/cm³, 0.925 g/cm³, 0.93 g/cm³, to an upper limit selected from one of 0.95 g/cm³, 0.955 g/cm³, 0.96 g/cm³, 0.965 g/cm³, 0.97 g/cm³, 0.98 g/cm³, 0.99 g/cm³, 1.0 g/cm³, 1.1 g/cm³, 1.2 g/cm³, or 1.3 g/cm³ where any lower limit may be combined with any suitable upper limit.

Tie layer films according to one or more embodiments may comprise a polymer (the co- or ter-polymer) having a melt index (I₂) measured according to ASTM D1238 (190° C. and a load of 2.16 kg) ranging from a lower limit of 0.01 g/10 min, 0.1 g/10 min, 0.5 g/10 min, 1 g/10 min, 2 g/10 min, 5 g/10 min, 10 g/10 min, 15 g/10 min, 20 g/10 min, 30 g/10 min, 40 g/10 min, or 50 g/10 min to an upper limit of 50 g/10 min, 60 g/10 min, 70 g/10 min, 80 g/10 min, 90 g/10 min, or 100 g/10 min where any lower limit may be combined with any suitable upper limit.

Tie layer films according to one or more embodiments may have a thickness ranging from a lower limit of 0.1 μm, 0.5 μm, 1 μm, 2 μm, 3 μm, 4 μm, 5 μm, 10 μm, 15 μm, 20 μm, 30 μm, 50 μm, 100 μm, 200 μm, 300 μm, 400 μm, or 500 μm, to an upper limit of 500 μm, 600 μm, 700 μm, 800 μm, 900 μm, or 1000 μm where any lower limit may be combined with any suitable upper limit.

Films for use as a tie layer may include, in addition to the co- or ter-polymer described herein, one or more of: a grafting agent in an amount of 0.01 to 1 phr; adhesion promoters in an amount of 0.01 to 15 phr; a primary antioxidant in an amount of 0.002 to 1 phr; a secondary antioxidant in an amount of 0.002 to 1 phr; a light stabilizer in an amount of 0.002 to 1 phr; an UV absorber in an amount of 0.002 to 1 phr; an acid scavenger in an amount of 0.002 to 1 phr; a processing aid in an amount of 0.002 to 1 phr; or optionally, additive(s) selected from the group comprising pigments, anti-fogging agents, antistatic agents, antiblock agents, clarifiers, nucleating agents, thermal stabilizers, plasticizers, rubbers, elastomers, fillers, and combinations thereof.

In one or more embodiments, films suitable for use as a tie layer may comprise a polymer having a density that ranges from a lower limit selected from one of 0.91 g/cm³, 0.915 g/cm³, 0.92 g/cm³, 0.925 g/cm³, 0.93 g/cm³, to an upper limit selected from one of 0.95 g/cm³, 0.955 g/cm³, 0.96 g/cm³, 0.965 g/cm³, or 0.97 g/cm³, where any lower limit may be combined with any suitable upper limit. In one or more embodiments, the polymer may have a density ranging from 0.92 g/cm³ to 0.96 g/cm³.

In one or more embodiments, films suitable for use as a tie layer may comprise a polymer having a melt index (I₂) measured according to ASTM D1238 (190° C. and a load of 2.16 kg) ranging from a lower limit of 0.01 g/10 min, 0.1 g/10 min, 0.2 g/10 min, 0.3 g/10 min. 0.4 g/10 min, 0.5 g/10 min, 1 g/10 min, 2 g/10 min, 5 g/10 min, 10 g/10 min, 15 g/10 min, 20 g/10 min, 25 g/10 min, 30 g/10 min, 40 g/10 min, or 50 g/10 min to an upper limit of 50 g/10 min, 60 g/10 min, 70 g/10 min, 80 g/10 min, 90 g/10 min, 100 g/10 min, 150 g/10 min, or 200 g/10 min where any lower limit may be combined with any suitable upper limit. In one or more embodiments, the polymer may have a melt index (I₂) ranging from 0.1 g/10 min to 100 g/10 min, or even from 0.2 g/10 min to 25 g/10 min.

In one or more embodiments, films suitable for use as a tie layer may comprise a polymer having a total comonomer content ranging from a lower limit of 0.1 wt %, 1 wt %, 2 wt %, 5 wt %, or 10 wt %, to an upper limit of 11 wt %, 20 wt %, 30 wt %, 40 wt %, 50 wt %, or 60 wt % where any lower limit may be combined with any suitable upper limit.

In one or more embodiments, films suitable for use as a tie layer may comprise a polymer having a melting temperature measured according to ASTM D3418 ranging from a lower limit of 30° C., 40° C., 50° C., or 60° C. to an upper limit of 60° C. 70° C., 90 ° C. 100° C., or 120° C. where any lower limit may be combined with any suitable upper limit. In one or more embodiments, the polymer may have a melting temperature of less than 120° C. or a melting temperature ranging from 60° C. to 100° C.

In one or more embodiments, films suitable for use as a tie layer may comprise a polymer having a contact angle measured according to ASTM D5946 of greater than 70°, or 75°, or 80°, or 85°, or 90°.

In one or more embodiments, films suitable for use as a tie layer may have a water vapor transmission coefficient measured according to ASTM F1249 of less than 25000 μm·g/m²·day, 24000 μm·g/m²·day, 23000 μm·g/m²·day, 22000 μm·g/m²·day, 21000 μm·g/m²·day, or 20000 μm·g/m²·day.

In one or more embodiments, films suitable for use as a tie layer may comprise a polymer composition which exhibits a glass transition temperature measured via tan 8 of less than 0° C., −5° C., −10° C., −15° C., −17° C., −19° C., −21° C., −23° C., or −25° C.

In one or more embodiments, films suitable for use as a tie layer may comprise a polymer composition which exhibits a glass transition temperature measured via loss modulus of less than 0° C., −5° C., −10° C., −15° C., −20° C., −25° C., −27° C., −29° C., −31° C., −33ºC, or −35° C.

### Methods of Film Preparation

Embodiments disclosed herein may relate to methods of preparing films which comprise a polymer composition according to the present disclosure. Methods may comprise preparing a polymer composition by blending a polymer produced from ethylene, one or more branched vinyl ester monomers, and optionally, vinyl acetate according to embodiments described herein, and optionally one or more of each of a grafting agent; an adhesion promoter; a primary antioxidant; a secondary antioxidant; an acid scavenger; a pigment; an anti-fogging agent; an antistatic agent; a processing aid; an antiblock agent; a clarifier; a nucleating agent; a light stabilizer; an UV absorber; a thermal stabilizer; a plasticizer; rubbers/elastomers; fillers; and combinations thereof.

Blending may be performed according to any suitable method, and may comprise using a twin screw extruder, single screw extruder, kneader, banbury mixer, mixing roller, a blown or a cast film extruder, in a blow molding extruder. The grafting reaction comprises of forming at least one covalent bond between a base polymer. Grafting may include, for example, melt grafting, solution grafting, or solid state grafting. Melt grafting can be perform in suitable equipment, such as twin screw extruder, single screw extruder, kneader, banbury mixer, other internal mixers, mixing roller, blown or cast film extruder, a blow molding extruder, etc.

The prepared polymer composition may then be used to prepare a film comprising the polymer composition, which may be formed as a distinct structure or in combination with one or more substrates. For example, the film may be produced via cast film extrusion, blown film extrusion, calendaring, extrusion blow molding, injection molding, injection stretch blow molding, pipe extrusion, thermoforming, or any other suitable method.

### Articles

Embodiments disclosed herein may relate to articles comprising at least one film disclosed herein. The article may comprise a substrate to which the film is applied. The article may comprise one or more than one substrate. For example, the film may be a tie layer, bonding together two different substrates. In embodiments comprising two or more substrates, the film may be comprised between two substrates as a tie layer.

In one or more embodiments, articles (e.g. multilayered blow molded articles, multilayered pipes, multilayered films, multilayered films and sheets for food packaging) may be prepared with a tie layer base on the polymer composition described above and specifically including the co- or ter-polymers described herein.

### Method of Preparing an Article

Embodiments disclosed herein may relate to methods of preparing articles comprising films according to embodiments disclosed herein. Methods may include applying a film to a substrate, wherein the applying comprises co-extrusion and/or extrusion coating of the film with the substrate. Articles may be prepared by cast film extrusion, blown film extrusion, extrusion blow molding, injection molding, injection stretch blow molding, pipe extrusion, thermoforming, calendaring, or any method which is suitable for preparing the desired article. Methods can be used to produced multilayered flexible packaging, as well as multilayered extrusion blow molded articles multilayered extruded pipes, multilayered thermoformed parts, etc ..

### Materials, Experimental Methods and Characterization

### Materials

Compositions based on ethylene, vinyl acetate and vinyl neodecanoate (VeoVA™10) were tested. Terpolymer samples DV001A and DV001B were produced in a high-pressure industrial asset that normally operates producing EVA copolymers. The general reactor conditions for the production of the terpolymers are described in Table 1.

TABLE 1

| Parameter | DV001A | DV001B |
|---|---|---|
| Pressure - reactor 1 (kgf/cm²) | 1820-1840 | 1820-1840 |
| Temperature - reactor 1 (average) (° C.) | 164.5 | 164.5 |
| Pressure - reactor 2 (kgf/cm²) | 1780-1800 | 1770-1790 |
| Temperature - reactor 2 (average) (° C.) | 161.7 | 163.7 |
| Production rate (kg/h)* | 6000 | 6000 |
| VA feed rate (kg/h) | 2850-3200 | 2400 |
| Ethylene feed rate (kg/h) | 4270 | 4300 |
| VeoVA ™10 feed rate (kg/h) | 800-900 | 1650 |

*Difference in feed rate sum and production rate due to condensation of the comonomers and their low pressure recycle gas/liquid compressor separator.
The condensed VeoVA ™10 was not reinjected.
Part of unreacted VeoVA ™10 remains soluble in the polymer, being removed in a further step of air purge at the silos.

Evidence of incorporation of the branched vinyl ester and vinyl acetate is seen in both the carbonyl (170-180 ppm) and alkyl regions (0-50 ppm) of the ¹³C NMR spectra (TCE-D2, 393.1 K, 125 MHz). ¹H NMR spectra (TCE-D2, 393.2 K, 500 MHz) exhibit peaks for vinyl acetate and branched vinyl ester (4.7-5.2 ppm) andethylene (1.2-1.5 ppm) as well as additional peaks in the alkyl region (0.5-1.5 ppm) indicative of the long alkyl chains on the branched vinyl ester monomers. Relative intensity of the peaks found in ¹H NMR and ¹³C NMR spectra are used to calculate monomer incorporation of branched vinyl ester and vinyl acetate in the co-/terpolymers.

### Neat Polymer Characterization

The content of VA and vVeoVa™10 were measured by 1 H NMR and ¹³C NMR (described above). Melting and crystallization behavior of the samples were studied by DSC. The experiments were carried out in a TA Instruments DSC Discovery-DSC 2500, under nitrogen according to ASTM D3418. Samples were cooled down from 200 to −20° C. and subsequently heated up to 200° C. with a rate of 10° C./min.

The density was measured according to ASTM D792, Vicat softening point (10N) according to ASTM D1525, Hardness (Shore A) according to ASTM D2240 and contact angle following ASTM D5946. The specimens for the measurements of density, Vicat, Hardness and contact angle were prepared by compression molding according to ASTM D4703, with a conditioning of at least 24 hours at 23ºC, 50% RH. Melt flow rate was evaluated at 190° C., 2.16 kg, following ASTM D1239.

### Film Extrusion

Cast films of the aforementioned polymers (neat) were produced in a cast film extruder Leonard OCS ME-20/2800-V3, with a flat die, chilled pulling rolls. Prior the extrusions the die was cleaned with the aid of a spatula and a brass wool. The temperature profile and melt temperature were limited to 140° C. in order to evaluate processability and aesthetics of the films under these conditions. Because of the strong adhesion of EVA films to the pinch rolls, they were previously covered with brown paper and chilled to approximately 9° C.

### Film Characterization

Relevant properties (optical, mechanical and barrier) were tested in neat films of the polymers, and they are exhibited in the tables below.

Optical properties (clarity, haze and transmittance) were measured as determined by ASTM D1003, gloss (45 and)60° according to ASTM D2457, water vapor transmission rate was measured according to ASTM F1249 (37.8° C., 100 RH, 1 atm), and tensile testing was performed according to ASTM D882 (crosshead speed of 500 mm/min, using an optic extensometer, where stress and strain at yield and break, and secant modulus (1%) were reported.

Glass transition temperature (T_{g}) for both neat and crosslinked samples were determined from the measurement of Tan 8 peak maximum of the samples during DMA measurements using a TA 800 DMA instrument in the tensile mode. Films (˜ 0.5 mm) were compression molded at 150° C., cooled to −150° C. and their viscoelastic response were evaluated through temperature sweep with a rate of 3° C./min while a preload force of 0.01 N with a frequency of 1Hz and amplitude of 15 μm was aplied. Storage modulus, loss modulus, and tan 8 (ratio of storage to loss modulus) was recorded as a function of temperature.

### EXAMPLES

Example 1: Neat polymer characterization—The basic properties of the aforementioned terpolymers (labeled DV001A, DV001B), as well as EVA benchmarks-Braskem S. A. grade HM728 and SK Chemicals Co. grade EVATANE 3345PV—are displayed in Table 2.

TABLE 2

| | | | | | EVATANE |
|---|---|---|---|---|---|
| Property | | DV001A | DV001B | HM728 | 3345PV |
| VA Content | Wt % | 28.3 | 24.1 | 28* | 33* |
| VeoVa content | Wt % | 5.6 | 9.3 | — | — |
| MFR | g/10 min | 6.9 | 5.2 | 5.9 | 35.7 |
| 190° C./2.16 Kg | | | | | |
| Density (Liquid | g/cm³ | 0.947 | 0.943 | 0.950* | 0.956 |
| displacement) | | | | | |
| Vicat | @ 10N (° C.) | 40.1 | 41.4 | 42 | 29 |
| Hardness | Shore A | 75.2 | 77.6 | 81.1 | 71.9 |
| Contact angle | ° | 86.6 | 80.3 | 83.7 | 94.4 |

*Data from technical datasheet.

Example 2: Neat films were prepared according to the film extrusion protocol described above. The films were collected and rolled with a brown paper in order to avoid blocking. The extrusion parameters were as follows:

TABLE 3

| | EVATANE | | | |
|---|---|---|---|---|
| Sample | 3345PV | HM728 | DV001A | DV001B |
| Zone 1 T (° C.) | 54 | 100 | 100 | 100 |
| Zone 2 T (° C.) | 70 | 130 | 130 | 130 |
| Zone 4 T (° C.) | 90 | 130 | 130 | 130 |
| Zone 4 T (° C.) | 90 | 135 | 135 | 135 |
| Head T (° C.) | 102 | 135 | 135 | 135 |
| Die T 1 (° C.) | 101 | 135 | 135 | 135 |
| Die T 2 (° C.) | 107 | 135 | 135 | 135 |
| Melt temperature | 104 | 138 | 139 | 140 |
| (° C.) | | | | |
| Target thickness (μm) | ~480 (center) | 451 | 493 | 487 |
| | ~550 (edges) | | | |
| Melt pressure (bar) | 100 | 224 | 189 | 193 |
| Screw speed (rpm) | 110 | 100 | 108 | 108 |
| Roll temperature (° C.) | 10 | 10 | 8.7 | 8.7 |
| Motor torque (A) | 3 | 3 | 3 | 3 |
| Pulling speed (m/min) | 3.7 | 3.7 | 3.7 | 3.7 |

Films were characterized according to the methods described above. Overall, similar optical properties are observed; with a slightly higher clarity and lower haze for the terpolymers compared to HM728, Table 4 and 5. Lower water vapor transmission coefficient was observed for the terpolymers, especially for DV001B, which contains the most VeoVa10 monomer, as seen Table 6.

TABLE 4

| | | | | | Transmittance | Film thickness |
|---|---|---|---|---|---|---|
| Sample | Clarity (%) | Gloss (45°) (%) | Gloss (60°) (%) | Haze (%) | (%) | (μm) |
| DV001A | 91.8 ± 1.6 | 77.9 ± 2.4 | 100 | 5.1 ± 1 | 93.8 ± 0.1 | 493 |
| DV001B | 94.3 ± 0.6 | 77 ± 3 | 100 | 5.1 ± 1.5 | 93.8 ± 0.1 | 487 |
| HM728 | 89.7 ± 1 | 77.9 ± 3.6 | 100 | 7.7 ± 1.8 | 93.9 ± 0.1 | 451 |
| EVATANE | 98.4 ± 0.2 | 86.2 ± 3.6 | 100 | 3.6 ± 1.6 | 94 ± 0.2 | 480 |
| 3345PV | | | | | | |

TABLE 5

| | Tensile Secant Modulus | Yield Strength | Strain at Yield | Stress at break | Strain at Break |
|---|---|---|---|---|---|
| Sample | (1%) (MPa) | (MPa) | (%) | (MPa) | (%) |
| DV001A | 15 ± 0.4 | 2.1 ± 0 | 21.1 ± 0.3 | 10.3 ± 0.2 | 890 ± 43 |
| DV001B | 16 ± 0.4 | 2 ± 0.1 | 19.1 ± 0.8 | 9.7 ± 0.7 | 850 ± 54 |
| HM728 | 20 ± 0.7 | 2.7 ± 0.1 | 23.4 ± 1 | 14.6 ± 0.5 | 940 ± 54 |
| EVATANE | 9 ± 0.2 | 1.5 ± 0.0 | 30.8 ± 1.7 | 8.1 ± 0.3 | 1440 ± 69 |
| 3345PV | | | | | |

TABLE 6

| | Water Vapor | Water Vapor | |
|---|---|---|---|
| | Transmission | Transmission | Film |
| | Rate | Coefficient | thickness |
| Sample | (g/m² · day) | (μm · g/m² · day) | (μm) |
| DV001A | 27.2 | 13400 | 493 |
| DV001B | 22.5 | 10900 | 487 |
| HM728 | 28.4 | 13800 | 485 |
| EVATANE 3345PV | 44.2 | 20700 | 468 |

The glass transition temperature was obtained for films prepared according to the methods described above (DMA). The results are as follows:

TABLE 7

| Sample | Tg (° C.) (Tan δ) | Tg (° C.) (Loss Modulus) |
|---|---|---|
| HM728 (Neat) | −19.9 | −29.3 |
| EVATANE 3345PV (Neat) | −22.6 | −30.2 |
| DV001A (Neat) | −21.4 | −32.8 |
| DV001B (Neat) | −21.6 | −33.1 |

It can be seen that the Tg of the terpolymers are very similar to each other, and they are comparable to the value measured for the 33 wt % VA EVA (EVATANE 3345PV)-slightly higher via tan δ, and lower via loss modulus. Both terpolymers presented lower Tg than EVA with 28 wt % VA (HM728). This is an indication that the studied terpolymers present good low temperature flexibility.

Thermal properties of neat samples were determined via DSC, according to the methodology previously described.

TABLE 9

| | Tm2 | Tc | ΔHm | ΔHc |
|---|---|---|---|---|
| Sample | (° C.) | (° C.) | (J/g) | (J/g) |
| HM728 (Neat) | 73.3 | 54.1 | 48.1 | 50.7 |
| EVATANE 3345PV (Neat) | 61.8 | 42.1 | 38.7 | 44.9 |
| DV001A (Neat) | 72.0 | 52.5 | 43.1 | 45.3 |
| DV001B (Neat) | 73.7 | 55.7 | 47.6 | 49.5 |

DSC data (melting temperature and enthalpy, as well as crystallization temperature and enthalpy) demonstrated the expected trend, even though DV001B presented similar behavior to HM728. One can see slightly lower Tm2, Tc and ΔH for DV001A compared to HM728. EVATANE 3345PV displayed a lower melting temperature and enthalpy, because of its higher VA content (and higher total mol % comonomer content).

Hence, the film properties shown above demonstrate that the films according to the present disclosure are suitable for being used as tie layer films, since they have good thermal properties, including good low-temperature flexibility and good optical properties, including higher clarity and lower haze compared to traditional EVA copolymer HM728.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein. except for those in which the claim expressly uses the words ‘means for’ together with an associated function.

What is claimed:

1. A tie layer film, comprising a polymer composition comprising:
a polymer produced from ethylene, one or more branched vinyl ester monomers, and optionally, vinyl acetate, with an ethylene content in an amount ranging from 40 to 99.9 wt %, and having a melt index (I₂) from 0.1 to 100 g/10 min, measured according to ASTM D1238 (190° C. and load of 2.16 kg).

2. The film according to claim 1, wherein the polymer composition further comprises one or more of:
a grafting agent in an amount of 0.01 to 1 phr;
an adhesion promoter in an amount of 0.01 to 15 phr;
a primary antioxidant in an amount of 0.002 to 1 phr;
a secondary antioxidant in an amount of 0.002 to 1 phr;
an acid scavenger in an amount of 0.002 to 1 phr;
a light stabilizer in an amount of 0.002 to 1 phr;
an UV absorber in an amount of 0.002 to 1 phr;
an anti-fogging agent in an amount of 0.002 to 1 phr;
a processing aid in an amount of 0.002 to 1 phr;
an antiblock agent in an amount of 0.002 to 1 phr; or
optionally, at least one additive selected from the group consisting of thermal stabilizers, plasticizers, rubbers, elastomers, fillers, antistatic agents, nucleating agents and combinations thereof.

3. The film according to claim 1, wherein the one or more branched vinyl ester monomers have the general structure (II): 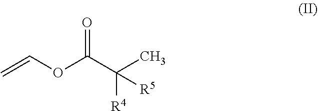
wherein R⁴ and R⁵ have a combined carbon number of 7.

4. The film according to claim 1, wherein the polymer has a total comonomer content ranging from 0.01 wt % to 60 wt %.

5. The film according to claim 1, wherein the polymer comprises a vinyl ester monomer in an amount ranging from 0.01 wt % to 60 wt.

6. The film according to claim 1, wherein the polymer has a density ranging from 0.8 g/cm³ to 1.3 g/cm³, measured according to ASTM D792.

7. The film according to claim 1, wherein the film has one or more of the following properties:
a water vapor transmission coefficient of less than 22000 μm·g/m²·day, measured according to ASTM F1249;
a melting temperature of less than 120° C., measured according to ASTM D3418;
a haze of less than 10%, measured according to ASTM D1003;
a gloss at 45° of at least 77%, measured according to ASTM D2457;
a gloss at 60° of at least 90%, measured according to ASTM D2457; and
a glass transition temperature of less than 0° C. via tan 8 and lower than 0° C. via loss modulus, as measured via DMA, tensile fixture, tension ° /min, according to ASTM D4065.

8. The film according to claim 1, wherein the polymer has a melt index (I₂) ranging from 0.2 g/10 min to 100 g/10 min, measured according to ASTM D1238 (190° C. and load of 2.16 kg).

9. The film according to claim 1, wherein the film has a thickness ranging from 0.5 μm to 1000 μm.

10. A method for producing a film comprising cast film extruding, blown film extruding, calendaring, extrusion blow molding, injection molding, injection stretch blow molding, pipe extruding, or thermoforming the film according to claim 1.

11. An article comprising two substrates and the film according to claim 1 therebetween.

12. The article of claim 11, wherein at least one of the substrates is formed by cast film extrusion, blown film extrusion, extrusion blow molding, injection molding, injection stretch blow molding, pipe extrusion, thermoforming, or calendaring.

13. The article of claim 11, wherein the article is selected from the group consisting of flexible food packaging, containers, bottles, blow molded tanks, and pipes.

14. A method of manufacturing an article, comprising:
applying a film according to claim 1 to a substrate; and
positioning a second substrate on the film.

15. The method of claim 14, wherein the applying comprises co-extrusion, extrusion coating, cast film extrusion, blown film extrusion, extrusion blow molding, injection molding, injection stretch blow molding, pipe extrusion, thermoforming, and/or calendaring of the film with the substrate.
